(19) United States
(12) Patent Application Publication
(10) Pub. No.: US 2025/0166051 A1
(43) Pub. Date: May 22, 2025

(54) SYSTEMS AND METHODS FOR GENERATING AN INTERACTIVE GRAPHICAL USER INTERFACE

(71) Applicant: Capital One Services, LLC, McLean, VA (US)

(72) Inventors: Xiaoguang ZHU, New York, NY (US); Jennifer KWOK, Brooklyn, NY (US); Tyler MAIMAN, Melville, NY (US)

(73) Assignee: Capital One Services, LLC, McLean, VA (US)

(21) Appl. No.: 18/512,269

(22) Filed: Nov. 17, 2023

(51) Int. Cl. G06Q 30/0601; G06F 9/451; G06F 16/9535; G06F 16/9538; G06Q 30/018

(52) U.S. Cl. CPC G06Q 30/0643; G06F 9/451; G06F 16/9535; G06F 16/9538; G06Q 30/018; G06Q 30/0631

(57) ABSTRACT

Systems and methods for generating an interactive graphical user interface (GUI) detailing impact data associated with an object, including receiving a user input associated with determining impact data for a first object, obtaining a transmission of a first data packet, generating a search query based on the data associated with the first object and the one or more features of interest of the first object, determining a second object in an inventory that corresponds to the search query, and generating the interactive GUI for display via the user interface.

### TECHNICAL FIELD

Various embodiments of this disclosure relate generally to generating an interactive graphical user interface (GUI) and, more particularly, to systems and methods for determining and providing impact data associated with one or more objects based on data associated with a first object.

### BACKGROUND

Conventional methods of online shopping often involve an enormous amount of pictures, information, and options provided to a potential buyer, especially if the potential buyer wishes to be cognizant of the impact of a particular purchase. For example, a user may wish to make a purchase with a lower carbon footprint, but that information is not easily determined and attempting to make that determination may be overwhelming or not apparent for potential buyers. The information overload-common for potential buyers in these conditions-often leads to chilling potential buyers' interest in continuing shopping and/or completing the sale.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating an interactive GUI.

In one aspect, a method for generating an interactive graphical user interface (GUI) detailing impact data associated with an object is disclosed. The method may comprise receiving, via one or more processors and from a user interface, a user input associated with determining impact data for a first object, the first object including one or more features of interest, and the user input being associated with a user; obtaining, via the one or more processors, a transmission of a first data packet, the first data packet comprising data associated with the first object; generating, via the one or more processors, a search query based on the data associated with the first object and the one or more features of interest of the first object; determining, via a trained machine learning model, a second object in an inventory that corresponds to the search query, wherein: the second object is determined based on the data associated with the first object and the one or more features of interest of the first object; and the inventory includes a plurality of objects; and generating the interactive GUI for display via the user interface, the interactive GUI including a section displaying the determined second object.

In another aspect, system is disclosed. The system may comprise at least one memory storing instructions; and at least one processor operatively connected to the memory, and configured to execute the instructions to perform operations for generating an interactive graphical user interface (GUI) detailing impact data associated with an object. The operations may include receiving, from a user interface, a user input associated with determining impact data for a first object, the first object including one or more features of interest, and the user input being associated with a user; obtaining a transmission of a first data packet, the first data packet comprising data associated with the first object; generating a search query based on the data associated with the first object and the one or more features of interest of the first object; determining, via a trained machine learning model, a second object in an inventory that corresponds to the search query, wherein: the second object is determined based on the data associated with the first object and the one or more features of interest of the first object; and the inventory includes a plurality of objects; and generating the interactive GUI for display via the user interface, the interactive GUI including a section displaying the determined second object.

In another aspect, a method for generating an interactive graphical user interface (GUI) detailing impact data associated with an object is disclosed. The method may comprise receiving, via one or more processors, a user input associated with determining impact data for a first object, the first object including one or more features of interest, and the user input being associated with a user; obtaining, via the one or more processors, a transmission of a first data packet, the first data packet comprising distribution data associated with the first object, impact data associated with the first object, and one or more user preferences of the user associated with the user input; generating, via the one or more processors, a search query based on the distribution data associated with the first object, the impact data associated with the first object, and the one or more user preferences of the user associated with the user input; determining, via a trained machine learning model, a second object in an inventory and impact data associated with the second object, the inventory corresponding to the search query and including a plurality of objects, wherein: the second object is determined based on the distribution data associated with the first object, the impact data associated with the first object, the one or more user preferences of a user associated with the user input, and the impact data associated with the second object; and generating the interactive GUI for display via a user interface, the interactive GUI including a section displaying the determined second object, a section displaying the impact data associated with the first object, and a section displaying the impact data of the second object.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating an interactive graphical user interface (GUI), according to one or more embodiments.

FIG. 2 depicts an exemplary method for generating an interactive GUI, according to one or more embodiments.

FIGS. 3A-3B depict exemplary schematics depicting generating and outputting interactive GUIs, according to one or more embodiments.

FIG. 4 depicts an example machine learning training flow chart, according to one or more embodiments.

FIG. 5 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “user” or the like may refer to a person using a device to request impact data and/or an interactive GUI. As used herein, terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person.

As used herein, the terms “inventory,” “inventory data,” and the like refer to one or more objects determined to match at least one feature of interest. For example, inventory data for a t-shirt may include t-shirts across one or more shopping platform(s), brand(s), style(s), color(s), composition(s), etc. Inventory data may be based on images, description (e.g., written, typed, etc.), product coding, etc. For example, inventory data may be determined by analyzing images of an object to determine one or more features of the object (e.g., color, style, fit, etc.). As used herein, the term “virtual object,” “object,” or the like may refer to a virtual representation of a merchant lot and/or a merchant stock, e.g., real-world items that may be virtually represented via a virtual object. For example, the picture of a stock item (e.g., a t-shirt) on a website may be a virtual object.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a user may utilize a browser plug-in to generate an interactive graphical user interface (GUI) detailing impact data associated with an object. A user may initiate generation of the interactive GUI by any suitable means, e.g., by hovering a mouse cursor over the image of a virtual representation of a first object on an item detail page of a merchant website, by interacting with the virtual representation of the first object to identify the first object to be added to a virtual cart of a merchant website, etc. Distribution data (e.g., the location of the storage facility storing a first object and/or a second object, the delivery address for the recipient (e.g., user), etc.) and/or impact data (e.g., carbon emissions associated with transporting the first object) may be determined for the first object. Additionally or alternatively, user preference data associated with the first object may be determined (e.g., a user preference associated with an object, a delivery method, etc.). Based on the determined distribution data for the first object, the determined impact data for the first object, and/or the determined user preference data for the first object, a first data packet may be generated and/or obtained by a recipient system, e.g., an inventory system.

One or more features of interest of the first object may be determined. Features of interest may include a type of item (e.g., shirt, pants, etc.), style of item (e.g., polo, t-shirt, etc.), a brand if the item, composition of the item (e.g., cotton, satin, etc.), other features (e.g., color, available size, etc.). The one or more features of interest may be determined using a trained machine learning model, e.g., a trained feature machine learning model.

A search query of an inventory may be generated based on one or more of the distribution data of the first object, impact data of the first object, the user preference data, the one or more features of interest, etc. A second object may be determined based on the search query. For example, the second object may be an object that has one or more similar features of interest as the first object and a lower carbon emission in delivery than the first object.

Based on the first object, the determined second object, and/or the data associated with the first object and/or the second object (e.g., distribution data, impact data, etc.), an interactive GUI may be generated for display, e.g., via a user device. The generated interactive GUI may include one or more recommendations (e.g., whether to purchase the first item or the second item, etc.), an actuator to cause to update the virtual shopping cart (e.g., to remove the first item and add the second item), etc. The generated interactive GUI may be caused to be output, e.g., via the user interface. The user may interact with the generated interactive GUI. For example, the user may select the actuator to update the virtual shopping cart.

While the examples above involve generating an interactive GUI for clothing shopping, it should be understood that techniques according to this disclosure may be adapted to any suitable method, e.g., shopping for other items, determining impact data for one or more options, etc. It should also be understood that the examples above are illustrative only. The techniques and technologies of this disclosure may be adapted to any suitable activity. Presented below are various systems and methods of generating an interactive GUI.

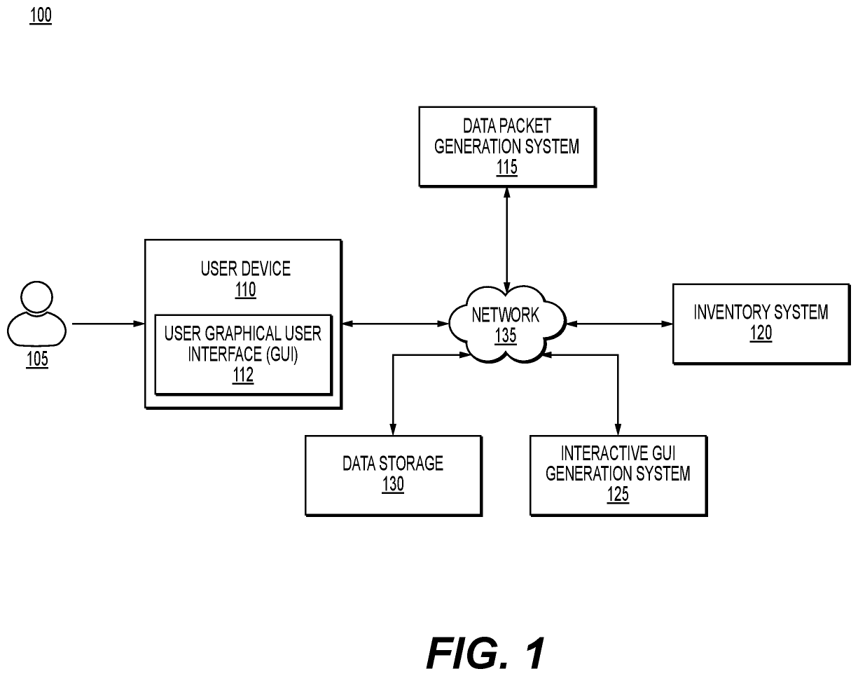

FIG. 1 depicts an exemplary environment for generating an interactive graphical user interface (GUI), according to one or more embodiments. Environment 100 of FIG. 1 depicts a user 105, a user device 110, a data packet generation system (hereinafter “data packet system”) 115, an inventory system 120, an interactive GUI generation system (hereinafter “GUI system”) 125, a data storage 130, and a network 135. User 105 may interact with user device 110 (e.g., via a GUI 112) to access one or more other aspects of environment 100. For example, data packet system 115, inventory system 120, GUI system 125, and/or data storage 130 may be accessed via user device 110.

User device 110 may be any suitable device (e.g., a computer, a smart phone, a smart watch, etc.). User device 110 may obtain data from one or more aspects of environment 100, e.g., from user 105 via GUI 112 (e.g., via one or more user inputs), data packet system 115, inventory system 120, GUI system 125, data storage 130, etc. User device 110 may transmit data to one or more aspects of environment 100, e.g., to data packet system 115, inventory system 120, GUI system 125, data storage 130, etc. The one or more user inputs may be any one or more of hovering a mouse cursor over a first object (e.g., on an item detail page of a merchant website), clicking (e.g., clicking on a Uniform Resource Locator (URL)), adding the first object to a virtual cart of a merchant website, etc.

Data packet system 115 may be configured to generate a user profile and/or one or more data packets. Data packet system 115 may obtain data from one or more aspects of environment 100, e.g., from user device 110, inventory system 120, GUI system 125, data storage 130, etc. Data packet system 115 may transmit data to one or more aspects of environment 100, e.g., to user device 110, inventory system 120, GUI system 125, data storage 130, etc.

Data packet system 115 may be configured to generate the user profile based on data obtained from user 105 (e.g., via GUI 112), third party systems (e.g., systems storing transaction history, etc.), other aspects of environment 100, etc. The user profile may contain user-specific information, such as the make, model, gas mileage, engine type, etc. of the car of user 105, the Global Positioning Service (“GPS”) location of user 105, etc. The user profile may be generated during an initialization phase, e.g., when user 105 downloads, activates, etc. the system hosting the interactive GUI generation system. The user profile may be modified by user 105, by data packet system 115, etc. For example, user 105 may update the user profile after buying a different car. In another example, data packet system 115 may be configured to update the user profile based on purchases, delivery locations, etc. by user 105.

Data packet system 115 may be configured to generate one or more data packets based on the user profile and/or data associated with an object (e.g., a first object, a second object, etc.), such as one or more of impact data associated with the first object, distribution data associated with the first object, user preference data associated with the first object, or feature of interest data associated with the first object. Impact data may include production method data (e.g., method(s) of producing an object), carbon emissions in production data, carbon emissions in distribution data, carbon emissions in delivery data, etc. Impact data may include user-specific information, such as the make, model, gas usage (e.g., miles per gallon, whether the car is battery powered), etc. of the car of user 105. Impact data may be determined by analyzing source code of the website in question. Impact data may be categorized on a scale, e.g., relative to an industry standard, a user-specific standard, etc. For example, an object with higher impact data (e.g., higher carbon emissions) may have a higher impact score than an object with lower impact data (e.g., lower carbon emissions). In another example, objects may be categorized, ranked, etc. Any suitable categorization, ranking, etc. system may be used, such as a numerical, value, percentage, etc., system. For example, objects may be ranked based on their respective impact data, such that an object with high impact data may be categorized as “red”, an object with mid-level impact data may be categorized as “yellow,” and an object with low impact data may be categorized as “green.”

Distribution data may include one or more object origination locations (e.g., one or more locations where an object is stored), one or more delivery locations (e.g., the residence of user 105, location of user 105 or intended recipient), one or more distribution methods (e.g., vehicle, airplane, boat, combinations thereof, etc.), one or more delivery methods (e.g., local mail, group delivery, individual delivery, combinations therefor, etc.), one or more distribution limitations (e.g., to move an object oversees cannot be fully transported via vehicle), one or more distribution requirements (e.g., to move an object oversees requires transportation via one or both of airplane and/or boat), etc. Distribution data may be determined by analyzing source code of a website in question.

User preference data may include one or more user-specific preferences associated with an object, e.g., size, color, composition, style, brand, etc. For example, user preference data may include that user 105 prefers crewneck t-shirts to V-neck t-shirts. User preference data may be determined from historical user transactions data, such features associated with the object (e.g., style, color, cut, etc.), a date of purchase, objects returned to the merchant, purchase price of the object, etc.

In some techniques, user preference data may be determined via a trained machine learning model, e.g., a trained user preference machine learning model. As discussed in further detail below, data packet system 115 may one or more of generate, store, train, and/or use a machine learning model configured to determine one or more user preferences. Data packet system 115 may include a machine learning model and/or instructions associated with the machine learning model, e.g., instructions for generating a machine learning model, training the machine learning model, using the machine learning model etc. Data packet system 115 may include instructions for retrieving historical user transaction data, adjusting one or more user preference data, e.g., based on the output of the machine learning model, and/or operating GUI 112 to output one or more user preference data, e.g., as adjusted based on the machine learning model. Data packet system 115 may include training data, e.g., training historical user transaction data, and may include ground truth, e.g., user preference data. The machine learning model of data packet system 115 may be trained to determine one or more user preferences based on at least the historical user transaction data. For example, if a user purchases various brands, colors, and sizes of t-shirts, but many of the t-shirts are crewneck, the style “crewneck” may be determined to be a user preference.

In some embodiments, a system or device other than data packet system 115 is used to generate and/or train the machine learning model. For example, such a system may include instructions for generating the machine learning model, the training data and ground truth, and/or instructions for training the machine learning model. A resulting trained machine learning model may then be provided to data packet system 115.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine learning model, e.g., compare the output of the trained model with the ground truth for that portion of the training data to evaluate an accuracy of the trained model. The training of the machine learning model may be configured to cause the machine learning model to learn associations between the training data and the ground truth data, such that the trained machine learning model is configured to determine an output one or more user preferences based on historical user transaction data.

In various embodiments, the variables of a machine learning model may be interrelated in any suitable arrangement in order to generate the output. For example, the machine learning model may include one or more convolutional neural networks (CNN) configured to identify features associated with the object, and may include further architecture, e.g., a connected layer, neural network, etc., configured to determine a relationship between the identified features in order to determine one or more user preferences.

In some instances, different samples of training data and/or input data may not be independent. Thus, in some embodiments, the machine learning model may be configured to account for and/or determine relationships between multiple samples. For example, in some embodiments, the machine learning model of data packet system 115 may include a Recurrent Neural Network (RNN). Generally, RNNs are a class of feed-forward neural networks that may be well adapted to processing a sequence of inputs. In some embodiments, the machine learning model may include a Long Short Term Memory (LSTM) model and/or Sequence to Sequence (Seq2Seq) model.

Feature of interest data may include one or more features of an object that a user may be interested in, such as color, style, price, fit, composition, etc. For example, for a user preference of Colombian coffee, “country of origin” may be a feature of interest. Feature of interest data may be dependent on the object. For example, feature of interest data for coffee (e.g., country of origin, type of roast, etc.) may vary from feature of interest data for protein powder (e.g., formulation, protein source (e.g., vegetarian, vegan, etc.), added flavoring, etc.). Feature of interest data may be determined using a trained machine learning model, e.g., a trained feature of interest machine learning model. The trained feature of interest machine learning model may be trained using one or more methods described herein.

Inventory system 120 may be configured to determine inventory data (e.g., available inventory) and/or generate a search query. Inventory system 120 may obtain data from one or more aspects of environment 100, e.g., from user device 110, data packet system 115, GUI system 125, data storage 130, etc. Inventory system 120 may transmit data to one or more aspects of environment 100, e.g., to user device 110, data packet system 115, GUI system 125, data storage 130, etc.

Inventory system 120 may be configured to determine inventory data by analyzing one or more websites. In some embodiments, inventory system 120 may be configured to analyze one or more websites to determine the website's industry, specialization, merchandise, etc. For example, inventory system 120 may be configured to determine the content, type of merchandise, etc. included on each of the one or more websites (e.g., whether the website includes clothes, coffee, workout equipment, etc.). The one or more websites may be categorized, organized, etc. by inventory system 120 such that similar websites are grouped together, e.g., clothing-based websites are a first grouping, food-based websites are a second grouping, etc. Websites may be included in more than one grouping, e.g., a website that sells many categories of items may be included in more than one grouping. The groupings may be sub-grouped, e.g., a grouping of clothing-based websites may be sub-grouped based on type of clothing, such as shirts, pants, shoes, etc. Any number of groupings and/or sub-groupings may be generated.

Inventory system 120 may be configured to analyze (e.g., via image, text, etc. analysis) the virtual objects (e.g., the images, videos, text descriptions, etc.) to determine the items available via the one or more websites. In some embodiments, inventory system 120 may be configured to analyze the virtual objects based on their grouping and/or sub-grouping, as described above. For example, inventory system 120 may be configured to analyze the virtual objects of websites in clothing-based groupings, such as in response to a search query for a t-shirt.

Inventory system 120 may generate the inventory during a configuration phase. For example, when user 105 downloads, activates, etc. the system hosting the interactive GUI generation system, inventory system 120 may be configured to generate inventory data (e.g., initial inventory data). Inventory system 120 may modify the inventory data, e.g., based on websites accessed by user 105, purchases made by user 105, determined user preferences, etc. The groupings, sub-groupings, and inventory data may be stored, e.g., in data storage 130.

Data associated with the objects may be associated with the determined inventory and/or stored, e.g., in data storage 130. For example, to determine an inventory of whole bean coffee, a plurality of coffee merchant websites may be analyzed, e.g., for whole bean coffee availability, and the data associated with the coffee (e.g., country of origin; light, medium, or dark roast; quantity; reviews; etc.) may be associated with the determined whole bean coffee inventory.

Inventory system 120 may be configured to generate a search query based on data obtained from any suitable aspect of environment 100, e.g., user device 110, data packet system 115, GUI system 125, data storage 130, etc. Inventory system 120 may generate one or more search queries based on inventory data (e.g., the determined inventory) and/or one or more of impact data, distribution data, user preference data, feature of interest data, inventory data (e.g., the determined inventory), etc. For example, inventory system 120 may generate a search query based on data associated with the first object, e.g., one or more of impact data, distribution data, user preference data, feature of interest data, etc. Inventory system 120 may be configured to output the one or more search queries to any suitable aspect of environment 100, e.g., user device 110, data packet system 115, GUI system 125, data storage 130, etc.

Inventory system 120 may be configured to generate one or more search queries based on one or more determined weights, e.g., relative weights of the one or more features of interest. In some embodiments, weights for each of the impact data, distribution data, user preference data, and/or the feature of interest data may be determined. The weight for each data point may be based on the determined value relative to the data point, e.g., higher levels of carbon emissions may be weighed more than a user preference. Any suitable method for setting and/or determining weights may be used.

GUI system 125 may be configured to generate and/or cause to output an interactive GUI, e.g., GUI 112. The interactive GUI may be caused to be output via a browser plug-in, an application programming interface (API), etc. The interactive GUI may include one or more of impact data, an actuator (e.g., a button, selector, drop down menu, etc. that when selected exchanges the first object for the second object in a virtual shopping cart), one or more recommendations, etc. GUI system 125 may obtain data from one or more aspects of environment 100, e.g., from user device 110, data packet system 115, inventory system 120, data storage 130, etc. GUI system 125 may transmit data to one or more aspects of environment 100, e.g., to user device 110, data packet system 115, inventory system 120, data storage 130, etc.

The one or more recommendations may include one or more of a purchase recommendation, object pickup or delivery recommendation, etc. For example, if a second object has lower impact data than a first object, GUI system 125 may generate a recommendation that user 105 purchase the second object instead of the first object. In another example, if picking up a first object in-store (rather than having it delivered) has lower impact data than a second object, GUI system 125 may generate a recommendation that user 105 purchase the first object instead of the second object. In some techniques, the one or more recommendations may be generated by a trained machine learning model, e.g., a trained recommendation machine learning model. The trained recommendation machine learning model may be trained using one or more methods described herein.

One or more of the components in FIG. 1 may communicate with each other and/or other systems, e.g., across network 135. In some embodiments, network 135 may connect one or more components of environment 100 via a wired connection, e.g., a USB connection between user device 110 and data storage 130. In some embodiments, network 135 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, inventory system 120 may be integrated in data packet system 115. In another example, user device 110 may further include data storage 130. In some embodiments, operations or aspects of one or more of the components discussed above may be distributed amongst one or more other components. In some embodiments, some of the components of environment 100 may be associated with a common entity, while others may be associated with a disparate entity. For example, data packet generation system 115, inventory system 120, interactive GUI generation system 125 may be associated with a common entity (e.g., an entity with which user 105 has an account) while data storage may be associated with a third party (e.g., a provider of data storage services). Any suitable arrangement and/or integration of the various systems and devices of the environment 100 may be used.

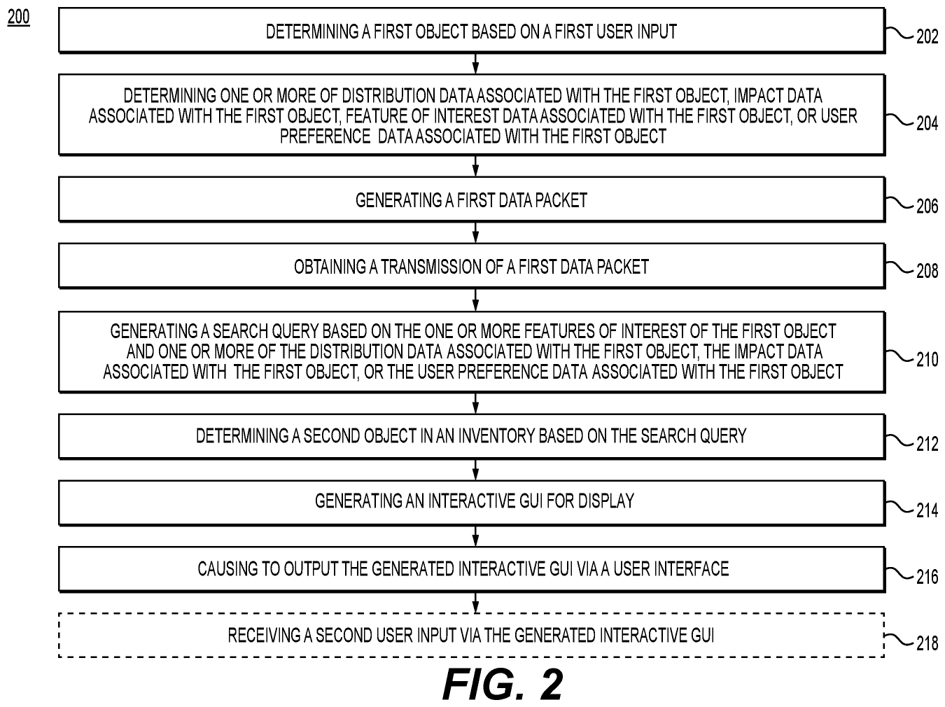

FIG. 2 depicts an exemplary method 200 for generating an interactive GUI, according to one or more embodiments. A user, e.g., user 105, may conduct online shopping. At step 202, a first object may be determined based on one or more user inputs (e.g., a first user input) received, e.g., while user 105 is conducting online shopping. As discussed herein, the first user input may be received by any suitable system, e.g., via GUI 112, and communicated to any suitable system, e.g., to data packet system 115, inventory system 120. GUI system 125, data storage 130, etc. The first user input may be associated with user 105 and/or with determining impact data for a first object. The user input may be in any suitable form, such as a cursor click, a cursor hover, focus on an area, viewing a product page, viewing a stock-keeping unit (SKU) page, adding an item to a virtual shopping cart, selecting an item, initiating a webpage, downloading a browser plug-in, initiating a browser plug-in, etc.

The first object may be determined based on the first user input. For example, if the first user input is user 105 clicking on a URL for a t-shirt, the t-shirt may be determined to be the first object based on the click. In another example, if the first user input is user 105 adding a t-shirt to a virtual shopping cart, the t-shirt may be determined to be the first object based on the shirt being added to the virtual shopping cart. As discussed in further detail below, which input determines the first object may be customized, e.g., by user 105.

In some techniques, receipt of the first user input may activate operation of a system hosting the interactive GUI generation system, e.g., a browser plug-in, API, etc. For example, the browser plug-in may become active upon user 105 beginning a web session, navigating to a commercial website, adding a virtual object to a virtual shopping cart, etc. In some techniques, the browser plug-in may operate continuously while user 105 conducts online shopping.

At step 204, data associated with the first object may be determined. The data associated with the first object may include one or more of distribution data associated with the first object, impact data associated with the first object, feature of interest data associated with the first object, user preference data associated with the first object, etc. In some techniques, the data associated with the first object may be determined by data packet system 115 scraping background data, cookies, etc. to determine the data associated with the first object, as described herein. The background data, cookies, etc. to be scraped may be determined based on the websites analyzed, e.g., by data packet system 115, as described above.

Feature of interest data may be used to determine one or more features of interest. For example, the feature of interest data associated with the first object may be used to determine one or more features of interest of the first object. In some techniques, the feature of interest of the first object may be determined via a trained machine learning model, e.g., a trained feature of interest machine learning model. For example, a machine learning model may be trained to determine the feature of interest data associated with the first object and/or the feature of interest of the first object based on historical user purchases (e.g., historical user purchases of the same or similar items), one or more aspects of the first object (e.g., size, style, colors, decorations, details, etc.), etc. As discussed in greater detail herein, any suitable machine learning techniques may be used.

In some implementations, the user preference data associated with the first object may be determined via a trained machine learning model, e.g., a trained user preference machine learning model. For example, a machine learning model may be trained to determine the user preference data associated with the first object based on historical user transactions data, features associated with the object (e.g., style, color, cut, etc.), a date of purchase, objects returned to a merchant, purchase price of the object, etc. As discussed in greater detail herein, any suitable machine learning techniques may be used.

At step 206, a first data packet may be generated. In some techniques, the first data packet may include data associated with the first object determined at step 204, e.g., one or more of distribution data associated with the first object, impact data associated with the first object, feature of interest data associated with the first object, user preference data associated with the first object, etc. The first data packet may be stored, e.g., in data storage 130.

In some techniques, feature of interest data and/or one or more features of interest may be determined after the first data packet is generated. For example, the first data packet may be determined based on distribution data associated with the first object and/or impact data associated with the first object, and the feature of interest data and/or one or more features of interest may be determined based on the first data packet. Similar techniques as described herein may be used to determine the feature of interest data and/or one or more features of interest. The feature of interest data may be obtained from the first data packet, data storage 130, etc.

At step 208, a transmission of the first data packet may be obtained. For example, the first data packet may be obtained by inventory system 120, GUI system 125, data storage 130, etc. For example, the first data packet may be obtained from data packet system 115, data storage 130, etc.

At step 210, a search query may be generated, e.g., a first search query. The search query may be generated based on the data associated with the first object (determined at step 204) and/or based on the data of the first data packet (generated at step 206). The search query may be generated based on available inventory. The available inventory may be determined as discussed herein, e.g., by analyzing one or more websites, website groupings, and/or website sub-groupings, as discussed in further detail above.

The search query may be generated via indexing, tokenizing, another suitable method, etc. For example, an available inventory may be determined based on the first object and/or the one or more features of interest of the first object. The available inventory may be indexed in a database by feature and the search query may be a query for the database. In another example, the database may be tokenized such that each feature is converted to a token, and querying is conducted by searching by a token value, e.g., a serial number corresponding to the feature. The search query may be executed to identify one or more second objects, as described in further detail below (see step 212).

At step 212, one or more second objects in an inventory may be determined based on the search query. In some techniques, the second object may be an object that has one or more similar features of interest as the first object and/or may have a lower carbon emission than the first object. For example, a second object (e.g., a crew-neck t-shirt) may be determined in comparison to a first object (e.g., a V-neck t-shirt) because the second object has a lower carbon emission in production, delivery, etc. relative to the first object.

Any suitable criteria may be used to determine the second object. In some embodiments, the one or more second objects may be determined, e.g., based on user's potential interest in a second object. The one or more second objects may be determined using any suitable data or criteria, e.g., one or more of the user profile, a user input (e.g., a first user input), distribution data, impact data, feature of interest data, user preference data, etc. associated with the first object and/or associated with the second object. For example, the second object may be determined based on user preferences (e.g., if the user prefers natural materials over synthetic, if the user prefers light colors over dark, if the user prefers V-neck style to crewneck, etc.).

In some embodiments, more than one second object may be determined. Each of the more than one second objects may be ranked, e.g., using techniques described herein, such as a numerical, value, percentage, etc. system. The more than one second objects may be ranked based on any criteria, such as one or more of the user profile, a user input (e.g., a first user input), distribution data, impact data, feature of interest data, user preference data, etc. associated with the first object and/or associated with the second object, and/or any number of criteria. For example, the more than one second objects may be ranked on a first criteria (similarity of each of the feature(s) of interest of the second objects to each of the feature(s) of interest of the first object) and based on a second criteria (impact data).

In some embodiments, the one or more second objects may be determined based on a predetermined threshold, e.g., based on the one or more features of interest, distribution data, etc. For example, the second object may be determined based on a determination that the second object is within a threshold distance to the user. The threshold may be user-specific. For example, the one or more features of interest of objects in an inventory may be compared to the one or more features of interest of the first object to a predetermined threshold (e.g., threshold of similarity) to determine the second object.

In some embodiments, the one or more second objects may be determined via a trained machine learning model. For example, a trained machine learning model may be used to determine one or more second objects based on one or more of distribution data, impact data, feature of interest data, user preference data, etc. As discussed in greater detail herein, any suitable machine learning techniques may be used.

At step 214, the system hosting the interactive GUI generation system may generate an interactive GUI for display via a user interface, e.g., GUI 112. As described in more detail below, the interactive GUI may include one or more components, e.g., results of the search query, impact data (e.g., for the first object, the second object, etc.), one or more recommendations, etc. As discussed in further detail below, the one or more recommendations may include a recommended alternative product, a recommended acquisition method, a recommended acquisition location, a recommended incentive, etc. For example, if a second object is determined to have lower emissions if acquired in-store, the system hosting the interactive GUI generation system may provide a recommended incentive (e.g., a coupon, money savings, etc.). In some embodiments, the user may customize the interactive GUI, e.g., to include and/or exclude one or more components.

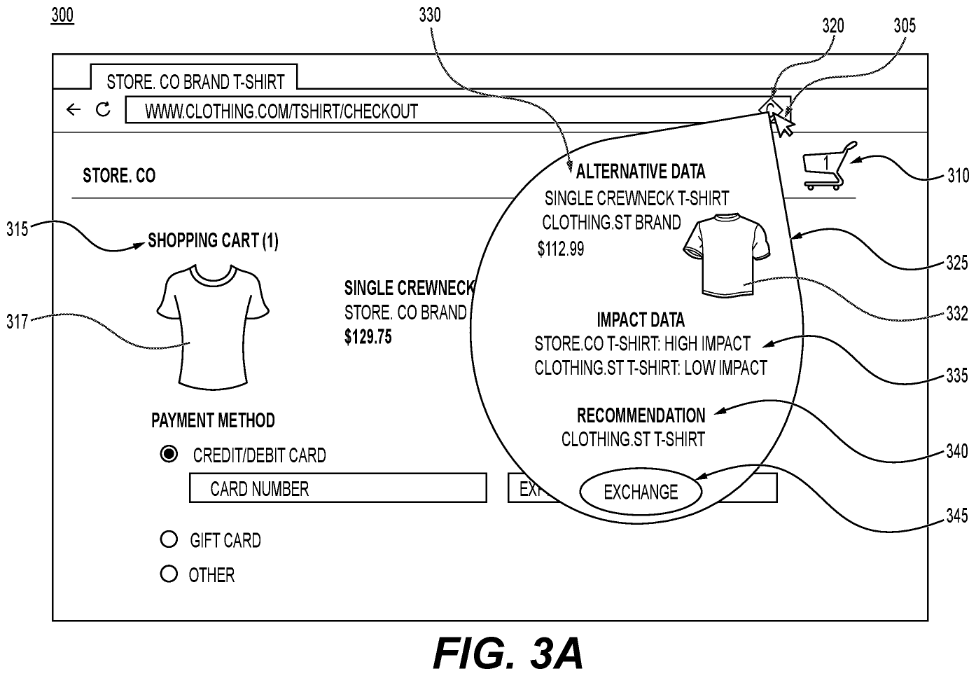

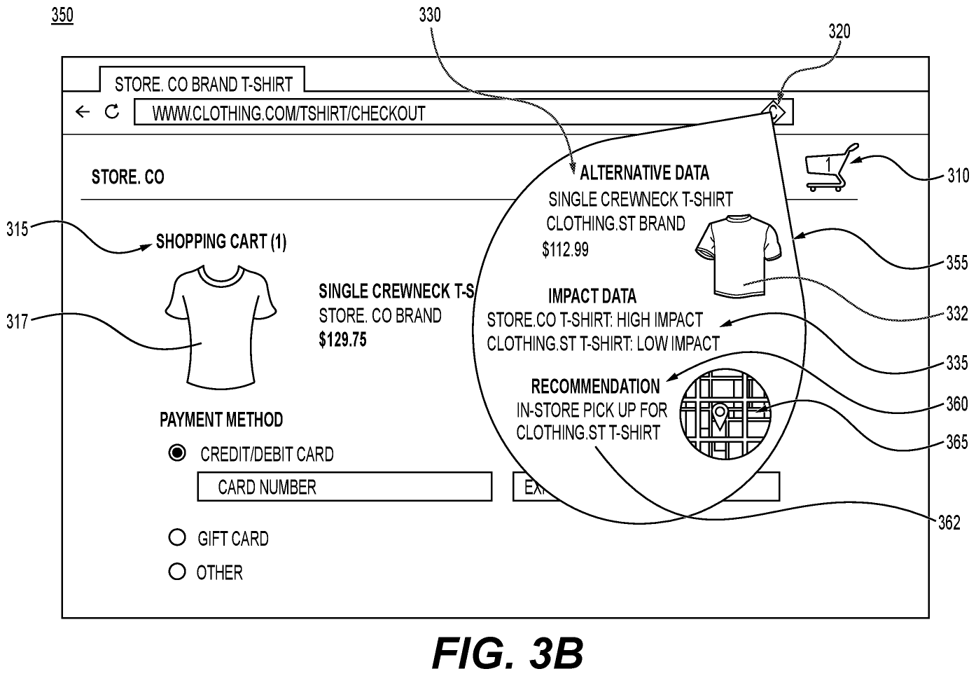

At step 216, the system hosting the interactive GUI generation system may cause to output the interactive GUI via a user interface, e.g., as depicted in FIGS. 3A and 3B. Browser 300 of FIG. 3A may include one or more of a virtual shopping cart icon 310, a virtual shopping cart 315, a browser plug-in icon 320, and/or an interactive GUI 325. A virtual object representing a first object (hereinafter referred to as “first object”) 317 may be depicted in virtual shopping cart 315. As depicted in FIG. 3A, a cursor 305 may hover over browser plug-in icon 320. Cursor 305 hovering over browser plug-in icon 320 may be the user input that, in this example, causes the system hosting the interactive GUI generation system 125 to generate the interactive GUI (see steps 202-214 above), e.g., interactive GUI 325.

Interactive GUI 325 may include one or more results of the search query (e.g., alternative data 330), impact data 335 (e.g., for the first object, the second object, etc.), one or more recommendations 340, an exchange actuator 345, etc. Alternative data 330 may include distribution data, impact data, feature of interest data, user preference data, one or more second objects (e.g., virtual object representing a second object (hereinafter referred to as “second object”) 332), etc. For example, if first object 317 is a Store.Co Brand Crewneck T-shirt, alternative data 330 may include a similar object, e.g., a Clothing.St Brand Crewneck T-shirt. Impact data 335 may include impact data for first object 317 and/or second object 332. One or more recommendations 340 may include a recommended object (e.g., between first object 317 or second object 332). For example, the system hosting the interactive GUI generation system may recommend (e.g., based on distribution data, impact data, user preference, etc.) first object 317 rather than second object 332, and may cause to output the recommended first object 317 via interactive GUI 325. In another example, the system hosting the interactive GUI generation system may recommend (e.g., based on distribution data, impact data, user preference, etc.) second object 332 rather than first object 317, and may cause to output the recommended second object 332 via interactive GUI 325. Exchange actuator 345 may enable a user (e.g., user 105) to initiate an exchange of first object 317 for second object 332, e.g., in virtual shopping cart 315.

Browser 350 of FIG. 3B may include similar aspects of browser 300 (e.g., virtual shopping cart icon 310, virtual shopping cart 315, first object 317, browser plug-in icon 320), and may further include an interactive GUI 355. As depicted in FIG. 3B, the addition of first object 317 to virtual shopping cart 315 may be the user input that, in this example, causes the system hosting the interactive GUI generation system to generate the interactive GUI (see steps 202-212 above), e.g., interactive GUI 355.

Interactive GUI 355 may include similar aspects of interactive GUI 325 (e.g., alternative data 330, impact data 335, etc.), and may further include one or more recommendations 360. One or more recommendations 360 may include a recommended acquisition method 362, a GPS location 365, etc. For example, recommended acquisition method 362 may include a procurement method (e.g., in-store pick-up) for the object (e.g., first object 317 and/or second object 332) based on the determined impact data (e.g., impact data 335), and GPS location 365. For example, a recommended acquisition method of in-store pick-up may be determined at least in part based on the make, model, gas usage (e.g., miles per gallon, whether the car is battery powered), etc. of the car of user 105, as discussed herein. GPS location 365 may be the GPS location of the store relative to the user (e.g., the distance from the user to the store) (e.g., for in-store pick-up of second object 332), the delivery address (e.g., the location of user 105), etc.

Returning to FIG. 2, optionally, at step 218, a second user input may be received via the generated interactive GUI associated with the user interface, e.g., at exchange actuator 345. For example, if a second user input is received at exchange actuator 345, an exchange of first object 317 for second object 332 may be initiated, e.g., in virtual shopping cart 315.

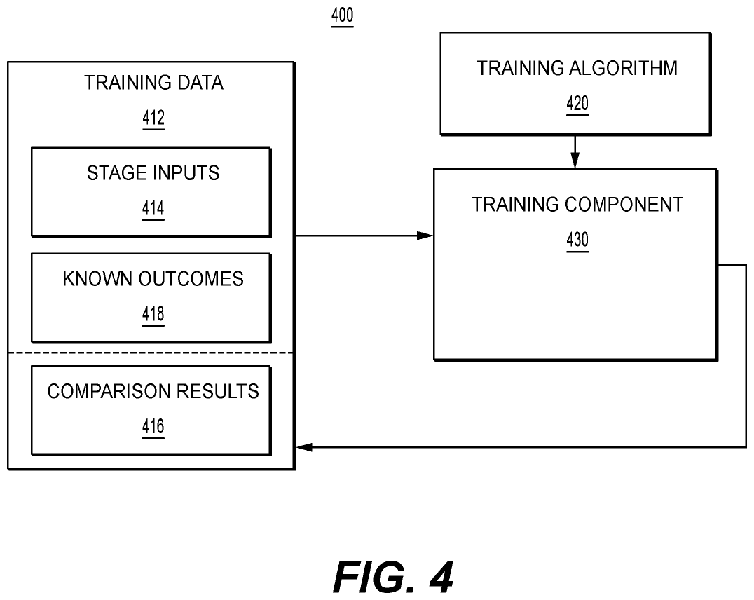

One or more implementations disclosed herein include and/or are implemented using a machine learning model, e.g., one or more of data packet system 115, inventory system 120, GUI system 125, etc., are implemented using a machine learning model and/or are used to train the machine learning model. A given machine learning model may be trained using the training flow chart 400 of FIG. 4. The training data 412 may include one or more of stage inputs 414 and the known outcomes 418 related to the machine learning model to be trained. The stage inputs 414 are from any applicable source including text, visual representations, data, values, comparisons, and stage outputs, e.g., one or more outputs from one or more steps from FIG. 2. The known outcomes 418 are included for the machine learning models generated based on supervised or semi-supervised training. An unsupervised machine learning model is not trained using the known outcomes 418. The known outcomes 418 includes known or desired outputs for future inputs similar to or in the same category as the stage inputs 414 that do not have corresponding known outputs.

The training data 412 and a training algorithm 420, e.g., one or more of the modules implemented using the machine learning model and/or are used to train the machine learning model, is provided to a training component 430 that applies the training data 412 to the training algorithm 420 to generate the machine learning model. According to an implementation, the training component 430 is provided comparison results 416 that compare a previous output of the corresponding machine learning model to apply the previous result to re-train the machine learning model. The comparison results 416 are used by the training component 430 to update the corresponding machine learning model. The training algorithm 420 utilizes machine learning networks and/or models including, but not limited to a deep learning network such as a transformer, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

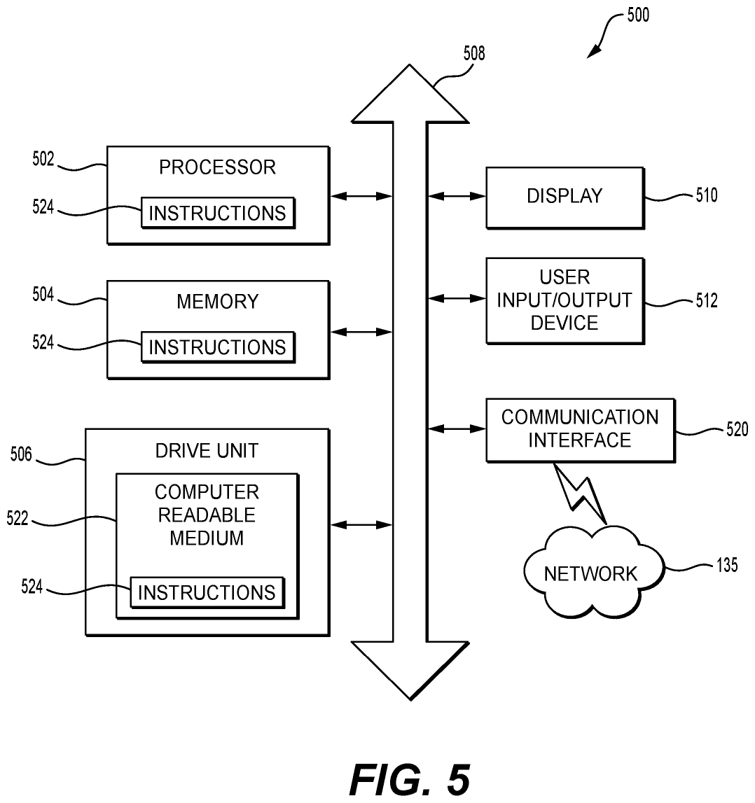

FIG. 5 depicts a simplified functional block diagram of a computer 500 that may be configured as a device for executing the methods disclosed here, according to exemplary embodiments of the present disclosure. For example, the computer 500 may be configured as a system according to exemplary embodiments of this disclosure. In various embodiments, any of the systems herein may be a computer 500 including, for example, a data communication interface 520 for packet data communication. The computer 500 also may include a central processing unit (CPU) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating an interactive graphical user interface (GUI) detailing impact data associated with an object, the method comprising:
receiving, via one or more processors and from a user interface, a user input associated with determining impact data for a first object, the first object including one or more features of interest, and the user input being associated with a user;
obtaining, via the one or more processors, a transmission of a first data packet, the first data packet comprising data associated with the first object;
generating, via the one or more processors, a search query based on the data associated with the first object and the one or more features of interest of the first object;
determining, via a trained machine learning model, a second object in an inventory that corresponds to the search query, wherein:
the second object is determined based on the data associated with the first object and the one or more features of interest of the first object; and
the inventory includes a plurality of objects; and
generating the interactive GUI for display via the user interface, the interactive GUI including a section displaying the determined second object.

2. The method of claim 1, further comprising:
generating the first data packet based on one or both of distribution data associated with the first object or the impact data associated with the first object.

3. The method of claim 2, further comprising:
determining the distribution data associated with the first object based on one or more of: one or more origination locations of the first object, one or more delivery locations of the first object, one or more distribution methods for the first object, one or more delivery methods for the first object, one or more distribution limitations of the first object, or one or more distribution requirements of the first object.

4. The method of claim 2, further comprising:
determining the impact data associated with the first object based on one or more of: production method data, carbon emissions in production data, carbon emissions in distribution data, or carbon emissions in delivery data.

5. The method of claim 1, wherein the data packet further includes one or more user preferences associated with the first object, and wherein the determining, via the trained machine learning model, the second object further includes determining the second object based on the one or more user preferences.

6. The method of claim 5, wherein the trained machine learning model has been trained to learn associations between training data to identify an output, the training data including a plurality of: distribution data associated with the first object, impact data associated with the first object, one or more features of interest of the first object, distribution data associated with the second object, impact data associated with the second object, one or more features of interest of the second object, or the one or more user preferences.

7. The method of claim 1, further comprising:
generating the impact data for each of the first object and the second object; and
generating the interactive GUI for display via the user interface, the interactive GUI including a section displaying the impact data for each of the first object and the second object.

8. The method of claim 1, wherein the user input includes adding an item to a virtual shopping cart.

9. The method of claim 1, further comprising:
receiving data associated with the second object, the data associated with the second object including location data of the second object;
determining, via the one or more processors, the location of the second object, the location of the user, and an acquisition method based on the determined location of the second object and the determined location of the user; and
upon determining the second object is located within a threshold distance of the location of the user, causing to display via the interactive GUI a section displaying the location of the second object and the acquisition method based on the determined location of the second object and the determined location of the user.

10. A system, the system comprising:
at least one memory storing instructions; and
at least one processor operatively connected to the memory, and configured to execute the instructions to perform operations for generating an interactive graphical user interface (GUI) detailing impact data associated with an object, the operations including:
receiving, from a user interface, a user input associated with determining impact data for a first object, the first object including one or more features of interest, and the user input being associated with a user;
obtaining a transmission of a first data packet, the first data packet comprising data associated with the first object;
generating a search query based on the data associated with the first object and the one or more features of interest of the first object;
determining, via a trained machine learning model, a second object in an inventory that corresponds to the search query, wherein:
the second object is determined based on the data associated with the first object and the one or more features of interest of the first object; and
the inventory includes a plurality of objects; and
generating the interactive GUI for display via the user interface, the interactive GUI including a section displaying the determined second object.

11. The system of claim 10, wherein the operations further include:
generating the first data packet based on one or both of distribution data associated with the first object or impact data associated with the first object.

12. The system of claim 11, wherein the operations further include:
determining the distribution data associated with the first object based on one or more of: one or more origination locations of the first object, one or more delivery locations of the first object, one or more distribution methods for the first object, one or more delivery methods for the first object, one or more distribution limitations of the first object, or one or more distribution requirements of the first object.

13. The system of claim 11, wherein the operations further include:
determining the impact data associated with the first object based on one or more of: production method data, carbon emissions in production data, carbon emissions in distribution data, or carbon emissions in delivery data.

14. The system of claim 10, wherein the data packet further includes one or more user preferences associated with the first object, and wherein the determining, via the trained machine learning model, the second object further includes determining the second object based on the one or more user preferences.

15. The system of claim 14, wherein the trained machine learning model has been trained to learn associations between training data to identify an output, the training data including a plurality of: distribution data associated with the first object, impact data associated with the first object, one or more features of interest of the first object, distribution data associated with the second object, impact data associated with the second object, one or more features of interest of the second object, or the one or more user preferences.

16. The system of claim 10, wherein the operations further include:
generating the impact data for each of the first object and the second object; and
generating the interactive GUI for display via the user interface, the interactive GUI including a section displaying the impact data for each of the first object and the second object.

17. The system of claim 10, wherein the user input includes adding an item to a virtual shopping cart.

18. The system of claim 10, wherein the operations further include:
receiving data associated with the second object, the data associated with the second object including location data of the second object;
determining, via the one or more processors, the location of the second object, the location of the user, and an acquisition method based on the determined location of the second object and the determined location of the user; and
upon determining the second object is located within a threshold distance of the location of the user, causing to display via the interactive GUI a section displaying the location of the second object and the acquisition method based on the determined location of the second object and the determined location of the user.

19. A method for generating an interactive graphical user interface (GUI) detailing impact data associated with an object, the method comprising:
receiving, via one or more processors, a user input associated with determining impact data for a first object, the first object including one or more features of interest, and the user input being associated with a user;
obtaining, via the one or more processors, a transmission of a first data packet, the first data packet comprising distribution data associated with the first object, impact data associated with the first object, and one or more user preferences of the user associated with the user input;
generating, via the one or more processors, a search query based on the distribution data associated with the first object, the impact data associated with the first object, and the one or more user preferences of the user associated with the user input;
determining, via a trained machine learning model, a second object in an inventory and impact data associated with the second object, the inventory corresponding to the search query and including a plurality of objects, wherein:
the second object is determined based on the distribution data associated with the first object, the impact data associated with the first object, the one or more user preferences of a user associated with the user input, and the impact data associated with the second object; and
generating the interactive GUI for display via a user interface, the interactive GUI including a section displaying the determined second object, a section displaying the impact data associated with the first object, and a section displaying the impact data of the second object.

20. The method of claim 19, further comprising:
receiving data associated with the second object, the data associated with the second object including location data of the second object;
determining, via the one or more processors, the location of the second object, the location of the user, and an acquisition method based on the determined location of the second object and the determined location of the user; and
upon determining the second object is located within a threshold distance of the location of the user, causing to display via the interactive GUI a section displaying the location of the second object and the acquisition method based on the determined location of the second object and the determined location of the user.
